(19) United States
(12) Patent Application Publication
(10) Pub. No.: US 2015/0199672 A1
(43) Pub. Date: Jul. 16, 2015

(54) CUSTOMER CHECK-IN DISPLAY DURING A TRANSACTION

(71) Applicant: Steven Yale Woloshin, San Jose, CA (US)

(72) Inventor: Steven Yale Woloshin, San Jose, CA (US)

(21) Appl. No.: 14/194,271

(22) Filed: Feb. 28, 2014

Related U.S. Application Data
(60) Provisional application No. 61/927,802, filed on Jan. 15, 2014.

(51) Int. Cl. G06Q 20/32; H04W 4/00

(52) U.S. Cl. CPC G06Q 20/3224; H04W 4/008

(57) ABSTRACT

There are provided systems and method for customer check-in display during a transaction. A user may check-in with a merchant, for example, through a server of the merchant, through the merchant device, or using automatic check-in services with a wireless beacon. When the user is ready to pay for items and/or services, the user may execute a process with a user device to notify the merchant that the user is ready to checkout and a transaction may be processed. The executed process may cause the check-in information for the user to appear on a display of the merchant or move to a top of a list of checked-in users. If the transaction is not processed, the check-in information may move to the bottom of the list or may return to its original spot. Once the transaction is completed, the check-in information may be removed.

### CROSS-REFERENCE TO RELATED APPLICATIONS

Pursuant to 35 U.S.C. §119(e), this application claims priority to the filing date of U.S. Provisional Patent Application Ser. No. 61/927,802, filed Jan. 15, 2014, which is incorporated by reference in its entirety.

### TECHNICAL FIELD

The present application generally relates to customer check-in display during a transaction and more specifically to receiving a request to display check-in information to a merchant for use in processing a transaction so the merchant may more easily complete the transaction.

### BACKGROUND

Users may utilize user devices at merchant locations to view items and/or services available with the merchant, receive sale items and/or services, and complete transactions with the merchant. For example, a user may be at a merchant location or a venue, such as a sporting event, and wish to purchase items and/or services from the merchant. The user may utilize check-in services with the merchant to provide the merchant with information about the user, potentially including payment information. However, if multiple users are checked-in to the same merchant, the merchant may have difficulty finding the correct user to process the user's transaction. Moreover, users who automatically check-in with the merchant may cause an overabundance of unused check-ins within a list of checked-in users.

### BRIEF DESCRIPTION OF THE DRAWINGS

FIG. 1 is a block diagram of a networked system suitable for implementing the processes described herein, according to an embodiment;

FIG. 2 is an exemplary system environment displaying a merchant device flagged by a user to display check-in information on payment, according to an embodiment;

FIG. 3 is a flowchart of an exemplary process customer check-in display during a transaction, according to an embodiment; and

FIG. 4 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

A user may utilize a user device at a merchant location to perform a check-in with that merchant location. The check-in may be effectuated through a wired and/or wireless connection with a merchant device directly at the merchant location, or through a wireless beacon, such as a Bluetooth Low Energy (BLE) beacon. The BLE beacon may create a check-in through establishing a connection between the beacon and the user device, and completing a check-in with the merchant device. In certain embodiments, the user device and/or the beacon may complete the check-in using a merchant server corresponding to the merchant location. Once a check-in process is completed with the merchant location, the user may be “checked-in” or associated with the merchant location so that user information corresponding to the user (e.g., user personal, financial, etc.) information is available for use at the merchant location.

The user may engage in shopping at the merchant location and decide to purchase items and/or services. In various embodiments, the merchant location may correspond to a merchant storefront or retail location. However, the merchant location may also correspond to vendors in vendors booths/stalls (e.g., at an event venue) or may correspond to mobile merchants (e.g., food trucks, stand-up vendors at venues, etc.). Once the checked-in user has selected items and/or services for purchase, the user may approach a payment counter at the merchant location and choose to purchase the items and/or services.

The merchant may account for all the items and/or services and create a purchase transaction for the user using a merchant device. The transaction may include a total for items and/or services to purchase and require a payment instrument to complete the transaction. Thus, the merchant may utilize the information submitted during the user check-in to complete the transaction or may request additional information (e.g., payment information) using the user check-in information. In order to facilitate the completion of the transaction, the user may “flag” or “wave” the merchant device so that the user's check-in information is displayed to the merchant on the merchant device. The request to display the check-in information to the user may correspond to a button in a payment or other application on the user device, a motion with the user device, or a distance or proximity of the user device to a merchant device (including a wireless beacon attached to the merchant device).

Once the request is received, the user check-in information may be displayed to the merchant. The display of the user check-in information may include bringing the user check-in to the front of an application interface on the merchant device (e.g., populating the user check-in information at the top of a check-in list on the merchant device). If the transaction is completed with the merchant, the check-in information may be deleted, or the merchant may choose to retain the check-in information to complete another transaction. However, if a transaction is not completed with the merchant (e.g., the user accidentally or otherwise selects the “wave” feature), the user check-in information may return to its original spot in the list or may be moved down the list. The number of times the user may select the “wave” feature may be limited to prevent malicious overuse and burdens on the merchant system.

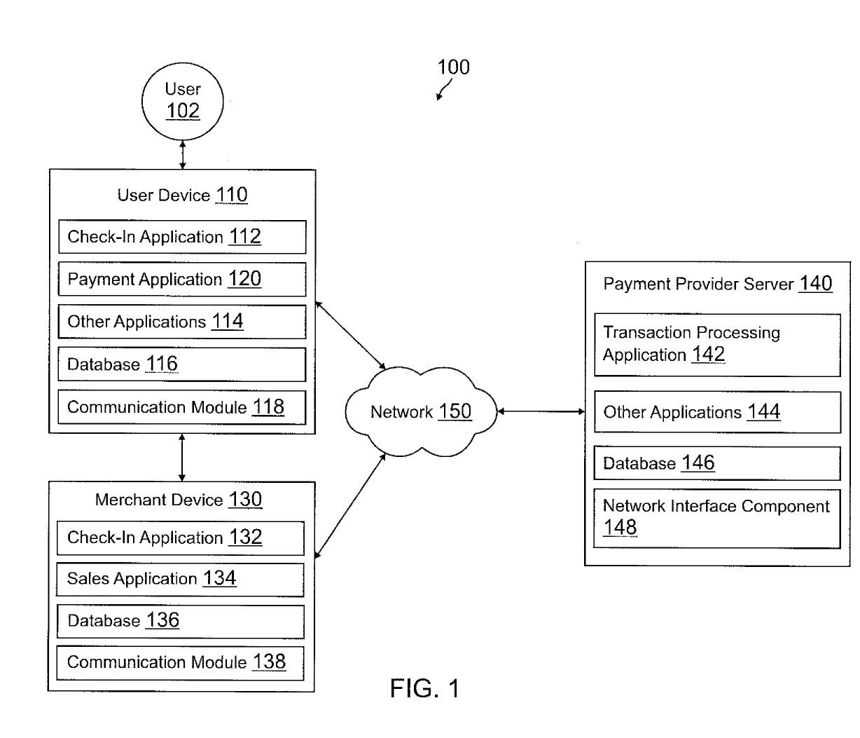

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a user device 110, a merchant device 130, and a payment provider server 140 in communication directly and/or over a network 150. User 102 may utilize user device 110 to check-in with merchant device 130 and process a transaction. While processing the transaction, user 102 may utilize user device 110 to “wave” or “flag” merchant device 130 through an application. The “wave” or “flag” may correspond to a request to display check-in information for user 102 on merchant device 130. Once check-in information is displayed, a merchant may utilize merchant device 130 to complete a transaction using, in various embodiments, payment provider server 140.

User device 110, merchant device 130, and payment provider server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 150.

User device 110 may be implemented using any appropriate hardware and software configured for wired and/or wireless communication with merchant device 130 and/or payment provider server 140. For example, in one embodiment, user device 110 may be implemented as a personal computer (PC), a smart phone, personal digital assistant (PDA), laptop computer, wristwatch with appropriate computer hardware resources, eyeglasses with appropriate computer hardware (e.g. GOOGLE GLASS @) and/or other types of computing devices capable of transmitting and/or receiving data, such as an IPAD® from APPLE®. Although a user device is shown, the user device may be managed or controlled by any suitable processing device. Although only one user device is shown, a plurality of user devices may be utilized.

User device 110 of FIG. 1 contains a check-in application 112, a payment application 120, other applications 114, a database 116, and a communication module 118. Check-in application 112, payment application 120, and other applications 114 may correspond to processes, procedures, and/or applications executable by a hardware processor, for example, a software program. In other embodiments, user device 110 may include additional or different software as required.

Check-in application 112 may be used by user 102 of user device 110 to establish a connection between user device 110 and merchant device 130. Check-in application 112 may correspond to a specific application utilized by user device 110 with merchant device 130 or a server corresponding to merchant device 130 to complete a check-in with merchant device 130. The check-in with merchant device 130 (or a server corresponding to merchant device 130) may correspond to a process to log in to a user account of user 102 with merchant device 130. In other embodiments, the check-in may provide and/or verify identity of user 102, including transmission of an identifier for user 102 and/or user device 110. The check-in may be completed directly with merchant device 130 using a connection with merchant device 130 (e.g., wired/wireless connection including BLE connection with a wireless beacon at merchant device 130, or over network 150 with the server corresponding to merchant device 130. In such embodiments, check-in application 112 may correspond more generally to a browser application configured to communicate with merchant device 130. Check-in information transmitted to merchant device 130 or determined by merchant device 130 based on information transmitted from user device 110 may include identifiers for user 102, user device 110, and/or a user account, user 102 information including personal and/or financial information, an image/photograph of user 102, or other identifying information for user 102.

Check-in application 112 may also correspond to an application available over the Internet for download from a server corresponding to merchant device 130 and/or payment provider server 140. Check-in application 112 may receive short range wireless communications with a wireless beacon connected to merchant device 130 to complete a check-in process, as previously discussed. For example, merchant device 130 may include infrastructure with a wireless beacon to communicate with user device 110 and complete the check-in process with merchant device 130.

Check-in application 112 may execute in the background of an operating system of user device 110 and be configured to establish connections, using communication module 118 of user device 110, with the wireless beacon at or connected to merchant device 130. The connection may be established with or without user input from user 102. For example, the wireless beacon may broadcast a token, such as a universally unique identifier (UUID), for reception by check-in application 112. Check-in application 112 may utilize communication module 118 of user device 110 to receive the token from the wireless beacon. If check-in application 112 acknowledges the UUID as identifying merchant device 130, a server for merchant device 130, and/or the wireless beacon, check-in application 112 may transmit an identifier corresponding to user 102 and/or user device 110 back to the wireless beacon. Check-in application 112 may utilize communication module 118 of user device 110 to communicate with the wireless beacon (e.g., over near field communication, Bluetooth, Bluetooth Low Energy, radio, infrared, or other connection). The identifier from user device 110 may include, be transmitted with, concatenated with, or otherwise bundled with the identifier received from the wireless beacon.

Once a connection is established with wireless beacon 152, user device 110 may be checked-in with merchant device 130 if user 102 has not previously been checked-in. The check-in process may then associate user 102 with merchant device 130. Check-in application 112 may receive information from merchant device 130. Check-in application 112 may receive transaction information and/or other merchant information, including information necessary to generate a transaction with merchant device 130 (e.g., a purchase list, summary of selected items and/or services, costs, etc. for use in generating a transaction). Since user 102 is already checked-in with merchant device 130, merchant device 130 may know an identifier of user device 110 and transmit the information to user device 110 using that identifier over network 150 and/or through the wireless beacon.

Check-in application 112 may utilize communication module 118 to pass information to merchant device 130, a server corresponding to merchant device 130, and/or payment provider server 140. Information passed to merchant device 130, a server corresponding to merchant device 130, and/or payment provider server 140 may include a user information, a transaction and/or transaction information, payment information, and/or a request to display user 102's check-in information on merchant device 130. In various embodiments, payment application 120 may be utilized to transmit and/or receive the aforementioned information or payment application 120 may transmit and/or receive the aforementioned information through check-in application 112 (e.g., through accessing an API of check-in application 112).

Payment application 120 may be used, for example, to provide a convenient interface to permit user 102 to select payment options and provide payment for items and/or services. For example, payment application 120 may be implemented as an application having a user interface enabling the user to enter payment options for storage by user device 110, provide payment options on checkout/payment of an item/service, and complete a transaction for the item/service. In certain embodiments, payment application 120 may correspond more generally to a web browser configured to view information available over the Internet or access a website corresponding to a payment service. Payment application 120 may utilize user financial information, such as a credit card, bank account, or other financial account. Additionally, payment application 120 may provide payment for items and/or services using a user account with payment provider, such as payment provider server 140.

If user 102 receives information to generate a transaction from merchant device 130 (e.g., available products/services and purchase options), user device 110 may generate a transaction and transmit the transaction to merchant device 130. However, in other embodiments, merchant device 130 may generate the transaction, for example, by “ringing up” or creating a total for one or more items and/or services to be purchased. Once the transaction is generated and available with merchant device 130, payment application 120 may “wave” or “flag” merchant device 130 by initiating a process to transmit a request to display user 102's check-in information on merchant device 130. The request may be transmitted to merchant device 130, and user 102's check-in information may be displayed on merchant device 130, as will be explained in more detail herein. Thus, payment application 120 may include a function to process and transmit the request to display user 102's check-in information on merchant device 130. The function may correspond to a button in payment application 120, a motion or action by user 102 while utilizing payment application 120, or other process. Once the function is selected by user 102 in payment application 120, merchant device 130 may display user 102's check-in information for selection by a merchant/salesperson using merchant device 130.

Additionally, payment application 120 may populate and/or transmit payment information for the transaction. For example, payment application 120 may populate a transaction form received from merchant device 130, transmit selected payment information to merchant device 130 and/or payment provider server 140, and/or generate a payment token from the transaction and/or selected payment information. Thus, payment application 120 may be used to generate a payment token and/or to complete a transaction.

In various embodiments, check-in application 112 and payment application 120 may be incorporated in the same application so as to provide their respective features in one convenient application interface.

User device 110 includes other applications 114 as may be desired in particular embodiments to provide features to user device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. In various embodiments, other applications 114 may include financial applications, such as banking, online payments, money transfer, or other applications associated with payment provider server 140. Where not provided by check-in application 112 and/or payment application 120, other applications may include browser applications and/or payment applications. Other applications 114 may contain software programs, executable by a processor, including a graphical user interface (GUI) configured to provide an interface to the user.

User device 110 may further include database 116 which may include, for example, identifiers such as operating system registry entries, cookies associated with check-in application 112, payment application 120, and/or other applications 114, identifiers associated with hardware of user device 110, or other appropriate identifiers, such as identifiers used for payment/user/device authentication or identification. In one embodiment, identifiers in database 116 may be used by a payment/credit provider, such as payment provider server 140, to associate user device 110 with a particular account maintained by the payment/credit provider. Database 116 may further include payment card information, including credit, debit, and/or gift card information. In various embodiments, database 116 may include online account access information. Database 116 may also store information for merchant device 130, a server corresponding to merchant device 130, and/or a wireless beacon corresponding to merchant device 130, such as identifiers, URL's and/or IP addresses, etc.

User device 110 includes at least one communication module 118 adapted to communicate with merchant device and/or payment provider server 140. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate directly with merchant device 130 instead of over network 150.

Merchant device 130 may be maintained, for example, by a merchant or seller offering various items and/or services through a merchant location. Generally, merchant device 130 may be maintained by anyone or any entity that receives money, which includes charities as well as retailers and restaurants. In other embodiments, merchant device 130 may be maintained by an entity offering items and/or services to user 102, such as merchants and/or service entities such as transportation services, food/restaurant services, or the like. In this regard, merchant device 130 may include a device having processing applications, which may be configured to interact with user device 110 and/or payment provider server 140 to facilitate the sale of items and/or services and process transactions for the items and/or services. Additionally, merchant device 130 corresponds to a device offering check-in services for user 102 with user device 110.

Merchant device 130 may be implemented using any appropriate hardware and software configured for wired and/or wireless communication with user device 110 and/or payment provider server 140. For example, in one embodiment, merchant device 130 may be implemented as a single or networked personal computer (PC), a smart phone, personal digital assistant (PDA), laptop computer, and/or other types of computing devices at a merchant location capable of transmitting and/or receiving data. Although a merchant device is shown, the merchant device may be managed or controlled by any suitable processing device. Although only one merchant device is shown, a plurality of merchant devices may be utilized.

Merchant device 130 includes a check-in application 132, a sales application 134, a database 136, and a communication module 138. Checkout/sales application 134 may correspond to processes, procedures, and/or applications executable by a hardware processor, for example, a software program. In other embodiments, merchant device 130 may include additional or different software as required

Check-in application 132 may correspond to processes to complete check-in with user device 110. Thus, check-in application 132 may correspond to an application of merchant device 130 configured to transmit and/or receive a check-in request from user device 110 and complete the check-in request. The check-in request may include log in information for a user account in database 136 and thus complete the check-in with user 102 by verifying the account information. However, in embodiments where a user account has not been previously established by user 102 and/or merchant device 130 does not offer user account services, check-in application 132 may receive other information for identifying user 102, include user name/identifier, user device identifier, a payment account/payment account identifier with payment provider server 140, or other information. In various embodiments, check-in application 132 and/or functions of check-in application 132 may be executed by a server corresponding to merchant device 130, as previously discussed. Check-in of user 102 with check-in application 132 may establish user 102's check-in information with merchant device 130. Check-in information may include identifiers for user 102, user device 110, and/or a user account, personal and/or financial information of user 102 (e.g., a name, address, payment card number, account number, etc.), an image of user 102, and/or other identifying information.

In various embodiments, merchant device 130 may include a wireless beacon configured to communicate with user device 110 directly instead of over network 150. Thus, check-in application 132 may be utilized to receive an identifier from user device 110 through a wireless beacon and complete check-in through the wireless beacon. The wireless beacon may transmit an identifier first to user device 110, such as a UUID, as previously discussed.

Once check-in is completed between user device 110 and merchant device 130, check-in application 132 may be utilized to communicate with user device 110. Thus, check-in application may transmit transactions, transaction information, and/or information to generate a transaction (e.g., a purchase option and/or purchase options available with merchant device 130). Check-in application 132 may be utilize to with user device 110 to transmit and/or receive information, including acceptance or refusal of a transaction, payment information for a transaction, and/or transaction histories documenting a transaction. In various embodiments, the aforementioned communication features may be executed with or by sales application 134.

Sales application 134 may be configured to provide a convenient interface to permit a salesperson to complete a transaction for an item with user 102. For example, sales application 134 may be implemented as an application having an interface enabling user 102 to pay for and/or pick-up items and/or services desired for purchase available at a merchant corresponding to merchant device 130. Thus, sales application 134 may include an interface displaying user purchasable items and/or services and terms of purchase (e.g. time, date, number, sale price, etc.). In some embodiments, sales application 134 may correspond more generally to a web browser configured to view merchant information available over the Internet or access a website corresponding to purchased items and/or services from a merchant. Thus, sales application 134 may also access a merchant website and engage in online transactions, for example, checking/finding inventory purchased by a user available at the merchant location or different merchant locations.

Sales application 134 further includes processes/procedures to receive a request to display user check-in information for user 102 and processes the request. For example, sales application 134 may receive the request from user device 110 and display user check-in information for user 102 on an interface/display of merchant device 130. Sales application 134 may process the request by moving the user check-in information to a top of a list having a plurality of user's check-in information. Thus, sales application 134 may bring it to the front of the interface or highlight the check-in information in a list. Displaying the check-in information may correspond to displaying a name for user 102 in the check-in information, an image/photograph of the user, and/or the user's identifiers and/or personal/financial information. A merchant using merchant device 130 may select to retain user 102's check-in information at the top of the list or the front of the interface. In other embodiments, as requests are received and processed by sales application 134 to display other user's check-in information, the check-in information for user 102 may be either moved down the list (e.g., one spot at a time based on the received requests) or return user 102's check-in information to an original spot in the list occupied by user 102's check-in information. In various embodiments, the aforementioned options may be selectable by a merchant using merchant device 130. Sales application 134 may enforce a limit on a number of “flags” or “waves” by user 102 in order to prevent user 102 from spamming the request to display user 102's information when user 102 is not currently completing payment for items and/or services with merchant device 130. In other embodiments, the merchant utilizing merchant device 130 may select to move the check-in information back to an original spot on the list is user 102 is not currently completing payment for the items and/or services.

Once user 102's check-in information is populated on a display of merchant device 130, a merchant may engage in a transaction with user 102. Thus, the merchant may transmit the transaction and/or transaction information to user device 110, may receive a transaction and/or payment information from user device 110, and/or may utilize the check-in information to complete a transaction with payment provider server 140. Once a transaction is completed, user 102's check-in information may be removed from merchant device 130 or may be stored for future transactions and/or moved elsewhere in the list of check-in information. In various embodiments, if a transaction is not completed with user 102's check-in information, user 102's check-in information may be moved elsewhere in the list, as previously discussed.

Merchant device 130 may further include database 136 which may include, for example, identifiers such as operating system registry entries, cookies associated with check-in application 132 and/or sales application 134, identifiers associated with hardware of merchant device 130, or other appropriate identifiers, such as identifiers used for device authentication or identification. In one embodiment, identifiers in database 136 may be used by a payment/credit provider, such as payment provider server 140, to associate merchant device 130 with a particular account maintained by the payment/credit provider. Database 136 may also store information for the merchant location corresponding to merchant device 130, including available items and/or services, item/service prices, etc.

In various embodiments, merchant device 130 includes at least one communication module 138 adapted to communicate with user device 110 and/or payment provider server 140. In various embodiments, communication module 138 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 138 may communicate directly with user device 110 instead of over network 150.

Payment provider server 140 may be maintained, for example, by an online payment service provider, which may provide payment services and/or processing for financial transactions on behalf of a user with a merchant. In this regard, payment provider server 140 includes one or more processing applications which may be configured to interact with user device 110 and/or merchant device 130 to facilitate payment for a transaction (e.g., a sale offer for an event admission ticket). In one example, payment provider server 140 may be provided by PAYPAL@, Inc. of San Jose, Calif., USA. However, in other embodiments, payment provider server 140 may be maintained by or include a credit provider, financial services provider, financial data provider, and/or other service provider, which may provide payment services to user 102.

Payment provider server 140 of FIG. 1 includes a transaction processing application 142, other applications 144, a database 146, and a network interface component 148. Transaction processing application 142 and other applications 144 may correspond to processes, procedures, and/or applications executable by a hardware processor, for example, a software program. In other embodiments, payment provider server 140 may include additional or different software as required.

Transaction processing application 142 may be configured to receive and/or transmit information from user device 110 and/or merchant device 130 for processing and completion of financial transactions for event admission tickets. Transaction processing application 142 may include one or more applications to process financial transaction information from user device 110 and merchant device 130 by receiving a payment request and/or token from user device 110 and/or merchant device 130 for completion of a transaction with merchant device 130. The payment token may correspond to a payment request from user 102 to merchant device 130. The payment token may be encrypted prior to transmission to transaction processing application 142. The payment token may include information corresponding to user identifiers, user financial information/identifiers, transaction information and/or identifiers, and/or merchant device 130 identifiers. Additionally, the payment token may include a payment request having payment amount and terms of payment for the transaction. Once received, transaction processing application 142 may utilize a payment account or financial information of the paying user to render payment for the sale offer. Payment may be made to merchant device 130 and/or a server corresponding to merchant device 130. Additionally, transaction processing application 142 may provide transaction histories, including receipts, to user device 110 and/or entity server for completion and documentation of the financial transaction.

In various embodiments, payment provider server 140 includes other applications 144 as may be desired in particular embodiments to provide features to payment provider server 140. For example, other applications 144 may include security applications for implementing server-side security features, programmatic server applications for interfacing with appropriate application programming interfaces (APIs) over network 150, or other types of applications. Other applications 144 may contain software programs, executable by a processor, including a graphical user interface (GUI), configured to provide an interface to a user.

Additionally, payment provider server 140 includes database 146. As previously discussed, user 102 may establish one or more user accounts with payment provider server 140. Database 146 may include user accounts having user information, such as name, address, birthdate, payment/funding information, additional user financial information, and/or other desired user data. User 102 may link a user account in database 146 to user device 110 through a user identifier, user device identifier, and/or user account identifier. Thus, when an appropriate identifier is transmitted to payment provider server 140, e.g. from user device 110 and/or merchant device 130, a user account belonging to user 102 may be found. However, in other embodiments, user 102 may not have previously established a user account. Thus, payment provider server 140 may complete a transaction based on other user financial information received from user device 110 and/or merchant device 130.

In various embodiments, payment provider server 140 includes at least one network interface component 148 adapted to communicate with network 150 including user device 110 and/or merchant device 130. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

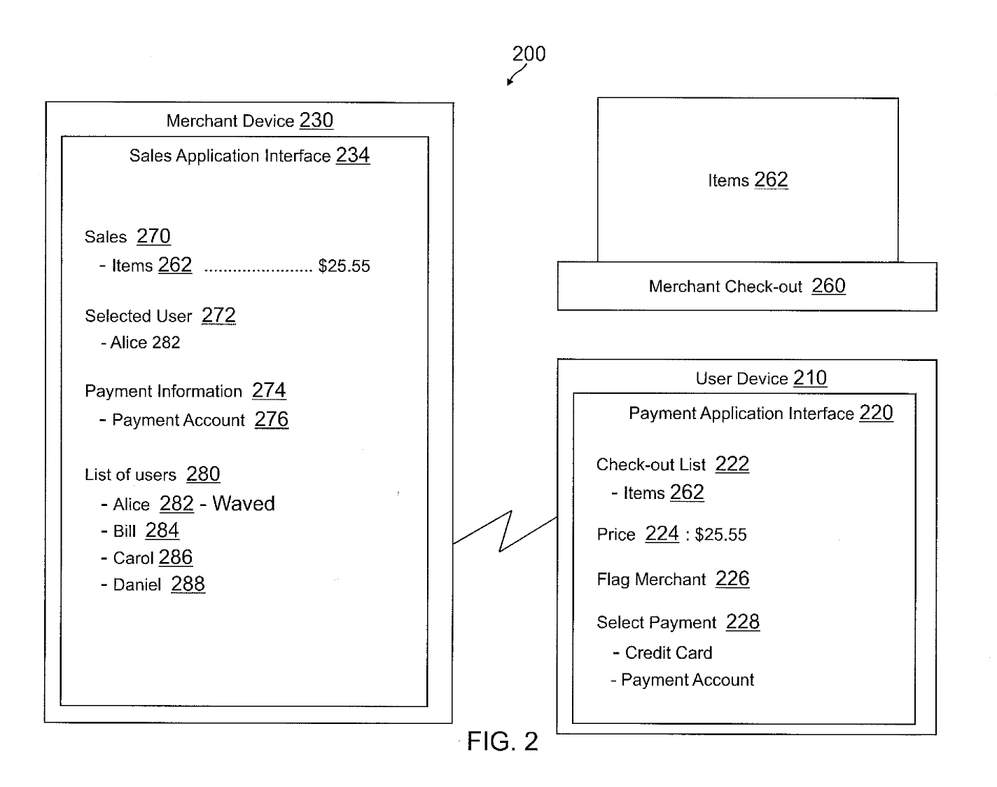

FIG. 2 is an exemplary system environment displaying a merchant device flagged by a user to display check-in information on payment, according to an embodiment. FIG. 2 includes a user device 210 and a merchant device 230 corresponding generally to user device 110 and merchant device 130, respectively, of FIG. 1.

In environment 200, a user Alice (not shown) brings items 262 to merchant check-out 260 in order to pay for the items. In other embodiments, Alice may arrive at check-out 260 to pay for services, such as a car wash, beauty treatment, etc. Thus, items 262 is not limited strictly to items/good/products and may incorporate other purchases. Alice utilizes user device 210 to complete payment for the items. User device 210 displays payment application interface 220 to assist Alice in completing payment for items 262. Payment application interface 220 may correspond generally to the described features and functions of payment application 120 of FIG. 1. Thus, Alice may view payment application interface 220 to view check-out list 222 having items 262, price 224, flag merchant button 226, and select payment buttons 228. Check-out list 222 may display a list of items for payment, shown in FIG. 2 as items 262 placed at merchant check-out 260. In other embodiments, check-out list 222 may also include items and/or services available with another merchant or a list of additional items and/or services for selection and payment at merchant check-out 260 (e.g., a menu of items and/or services). Once Alice has completed selection of items 262 (and/or other items/services) and is ready to complete the transaction, price 224 may display a price for the transaction. Price 224 includes $25.55 for the items selected by Alice, items 262. Thus, Alice can determine a payment method of items 262 based on price 224.

Once Alice is ready to pay for the items and/or services and is at the front of merchant check-out 260 (i.e., Alice is the customer currently completing a transaction shown on a sales application interface 234 of merchant device 230), Alice can flag the merchant with Alice's check-in information to complete the transaction. Thus, flag merchant button 226 corresponds to a process transmitted to merchant device 230 that displays Alice's check-in information on merchant device 230. Flag merchant button 226 may highlight, bring to the top of a list, or otherwise make Alice's check-in information apparent on merchant device 230. By selecting flag merchant button 226, Alice notifies merchant device 230 that Alice is ready to complete the transaction and apprises the merchant using merchant device 230 of Alice's check-in information (including potentially payment information) in order to complete the transaction. In other embodiments, Alice may shake user device 210 or perform some other action with user device 210 to “flag” merchant device 230 (i.e., transmit the process of flag merchant button 226). Alice may also use select payment 228 to select a payment method for use with Alice's check-in information, such as a credit card stored with user device 210 or Alice's payment account with a payment provider.

The merchant utilizing merchant device 230 may complete transactions with Alice using sales application interface 234. Sales application interface 234 may correspond generally to the described features and functions of sales application 134 of FIG. 1. Utilizing sales application interface 234, the merchant may view sales 270, selected user 272, payment information 274 and list of users 280. Sales 270 may correspond to selected items for sale, item 262, and a price for the items, $25.55. Thus, sales 270 correspond to a transaction with Alice for completion. The merchant may complete the transaction with Alice through selected user 272. As previously discussed, Alice utilizes user device 210 to flag merchant device 230 of Alice's check-in information. List of users 280 shows a list of user's check-in information, having check-in information for Alice 282, Bill 284, Carol 286, and Daniel 288. As shown next to Alice 282 is waved signifying that the check-in information Alice 282 has been brought to the top of list of users 280 or highlighted. Thus, the merchant viewing sales application interface 234 may easily select the check-in information for Alice, Alice 282. As shown in FIG. 2, check-in information for Alice shows Alice's name as Alice 282. However, in other embodiments, displaying the check-in information may correspond to displaying an image/photograph of the user and/or the user's identifiers and/or personal/financial information.

Once the merchant selects Alice 282, selected user 272 may populate with Alice's check-in information. Thus, selected user 272 may display Alice 282. The merchant may then transmit the transaction under sales 270 to user device 210 and may receive information to complete the transaction. As shown in FIG. 2, payment information 274 includes payment account 276 for completion of the transaction. Payment account 276 may correspond to a payment account of Alice's with a payment provider and may be received from user device 210 when Alice selects the payment account under select payment 228.

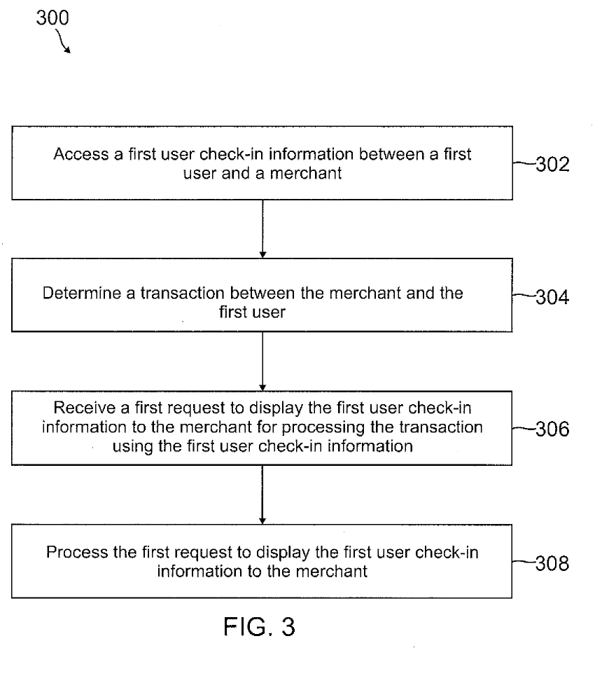

FIG. 3 is a flowchart of an exemplary process customer check-in display during a transaction, according to an embodiment. Note that one or more steps, processes, and methods described herein may be omitted, performed in a different sequence, or combined as desired or appropriate.

At step 302, a first user check-in information between a first user and a merchant is accessed. The first user check-in information is established between the first user and the merchant through a server corresponding to the merchant. Thus, the user device may connect to a network and complete a check-in over the network with a server. The server may be in communication with a merchant device at the merchant and check the user in to the merchant.

The first user check-in information may be established between the first user and the merchant using a wireless connection between a user device of the first user and a merchant device of the merchant. In such embodiments, the merchant device may comprise a wireless beacon in connection with user device without user input. For example, the merchant may provide short range wireless communications with a user device, such as through Bluetooth Low Energy (BLE) beacon communications. These beacons may be set up to communicate with the user device and alert users of check-in services through their user device. The beacons may provide additional functionality, such establishing a connection with a server entity to complete transactions, including check-in services. The beacons may also provide communication with a device attached to the beacon and/or server communicating with the beacon. Thus, utilizing the BLE beacon, the merchant may effectuate a check-in with the user device of the user.

A transaction between the merchant and the first user may be determined, at step 304. The transaction may be for a sale of items and/or services to the user. Thus, at step 306, a first request to display the first user check-in information to the merchant may be received for processing the transaction using the first user check-in information. The first request may simply bring to the front of an interface the first user check-in information. In other embodiments, the first request may comprise a request to move the first user check-in information for the first user to a top of a list of a plurality of user check-in information. The first request may be transmitted by a user device of the first user through an application button and/or motion with the user device. The user may select to retain the first user check-in information at the top of the list or to only lower the first user check-in information a spot if another user's check-in information is received.

At step 308, the first request to display the first user check-in information to the merchant is processed. The first user check-in information may be returned to an original spot in the list if the transaction is not processed. In other embodiments, a second user check-in information may be moved to the top of the list based on a second request from a second user. The first user check-in information may be removed from the list when the transaction is processed, or may be retained by the merchant if another transaction is to be processed.

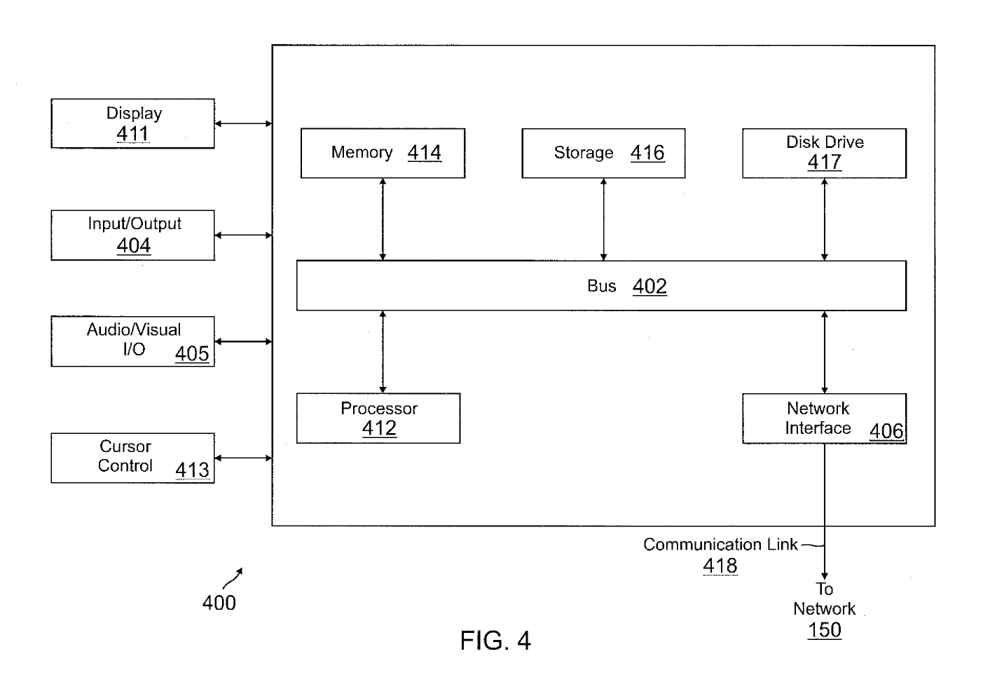

FIG. 4 is a block diagram of a computer system suitable for implementing one or more components in FIG. 1, according to an embodiment. In various embodiments, the user device may comprise a personal computing device (e.g., smart phone, a computing tablet, a personal computer, laptop, PDA, Bluetooth device, key FOB, badge, etc.) capable of communicating with the network. The merchant device and/or service provider may utilize a network computing device (e.g., a network server) capable of communicating with the network. It should be appreciated that each of the devices utilized by users and service providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons, image, or links, and/or moving one or more images, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant device, or a service provider server via network 150. In one embodiment, the transmission is wireless, although other transmission mediums and methods may also be suitable. One or more processors 412, which can be a micro-controller, digital signal processor (DSP), or other processing component, processes these various signals, such as for display on computer system 400 or transmission to other devices via a communication link 418. Processor(s) 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor(s) 412 and other components by executing one or more sequences of instructions contained in system memory component 414. Logic may be encoded in a computer readable medium, which may refer to any medium that participates in providing instructions to processor(s) 412 for execution. Such a medium may take many forms, including but not limited to, non-volatile media, volatile media, and transmission media. In various embodiments, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory storing user information comprising a first user check-in information with a merchant; and
one or more hardware processors in communication with the non-transitory memory and configured to:
access the first user check-in information between a first user and the merchant;
determine a transaction between the merchant and the first user;
receive a first request to display the first user check-in information to the merchant for processing the transaction using the first user check-in information; and
process the first request to display the first user check-in information to the merchant.

2. The system of claim 1, wherein the first request comprises a request to move the first user check-in information for the first user to a top of a list of a plurality of user's check-in information.

3. The system of claim 2, wherein the first user check-in information is returned to an original spot in the list if the transaction is not processed.

4. The system of claim 2, wherein the one or more hardware processors is further configured to:
receive a second request to move a second user check-in information for a second user to the top of the list; and
move the first user check-in information down the list if the transaction is not processed.

5. The system of claim 2, wherein the one or more hardware processors is further configured to:
remove the first user check-in information from the list if the transaction is processed.

6. The system of claim 2, wherein the first user check-in information remains at the top of the list based on a command by the merchant.

7. The system of claim 1, wherein the first user check-in information is established between the first user and the merchant using a wireless connection between a user device of the first user and a merchant device of the merchant.

8. The system of claim 7, wherein the merchant device comprises a wireless beacon in connection with user device without user input.

9. The system of claim 1, wherein the first user check-in information is established between the first user and the merchant through a server corresponding to the merchant.

10. The system of claim 1, wherein the first request is transmitted by a user device of the first user.

11. The system of claim 10, wherein the first user performs one of a button selection in an application of the user device and a motion with the user device to transmit the request.

12. A method comprising:
accessing a first user check-in information between a first user and a merchant;
determining a transaction between the merchant and the first user;
receiving a first request to display the first user check-in information to the merchant for processing the transaction using the first user check-in information; and
processing, using one or more hardware processors of a server, the first request to display the first user check-in information to the merchant.

13. The method of claim 12, wherein the first request comprises a request to move the first user check-in information for the first user to a top of a list of a plurality of user's check-in information.

14. The method of claim 13, wherein the first user check-in information is returned to an original spot in the list if the transaction is not processed.

15. The method of claim 13 further comprising:
receiving a second request to move a second user check-in information for a second user to the top of the list; and
moving the first user check-in information down the list if the transaction is not processed.

16. The method of claim 13 further comprising:
removing the first user check-in information from the list if the transaction is processed.

17. The method of claim 13, wherein the first user check-in information remains at the top of the list based on a command by the merchant.

18. The method of claim 12, wherein the first user check-in information is established between the first user and the merchant using a wireless connection between a user device of the first user and a merchant device of the merchant.

19. The method of claim 12, wherein the first user check-in information is established between the first user and the merchant through a server corresponding to the merchant.

20. A non-transitory computer readable medium comprising a plurality of machine-readable instructions which when executed by one or more processors of a server are adapted to cause the server to perform a method comprising:
accessing a first user check-in information between a first user and a merchant;
determining a transaction between the merchant and the first user;
receiving a first request to display the first user check-in information to the merchant for processing the transaction using the first user check-in information; and
process the first request to display the first user check-in information to the merchant.
